(19) United States
(12) Patent Application Publication
(10) Pub. No.: US 2007/0018433 A1
(43) Pub. Date: Jan. 25, 2007

(54) Medication cart with height adjustment

(76) Inventors: Andrew W. Sinnamon, Waterford (CA); Sebastian D. Alucema, Hamilton (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/175,184

(22) Filed: Jul. 7, 2005

(51) Int. Cl. B62B 1/00

(52) U.S. Cl. 280/651

(57) ABSTRACT

The cart has a base, with casters at each corner. A cabinet body is slidable vertically relative to the base on telescoping members at opposite sides of the cart. Hydraulic cylinders, operated by a hand crank, raise and lower the cabinet body. The cabinet body has a number of lockable drawers, and is provided with an anti-tip mechanism so that only one drawer may be opened at a time. The cart is particularly useful for dispensing of medication in a health care setting, though it may have many other uses.

### REFERENCE TO RELATED APPLICATION

This is a formal application based on and claiming the benefit of U.S. provisional patent application No. 60/585,082, filed Jul. 6, 2004.

### BACKGROUND OF THE INVENTION

This invention relates to a cart having a raisable and lowerable body. The cart is particularly useful as a medication cart, but could be used for other purposes if desired.

For convenience throughout this description, the cart will be referred to as a medication cart, but it should be clearly understood that this is not intended to limit the invention to use as a medication cart only. Similarly, reference to nurses and medications carried in the cart should not be used to imply that the invention does not apply to use by persons other than medical personnel or to carry items other than medication and medical equipment.

A typical prior art medication cart is normally used with a system for administering medication to patients in a general or acute hospital, or in a long term care facility. The cart has casters, permitting it to be pushed by a nurse from room to room. The cart has many drawers. The drawers contain medicine and instructions for the administration of the medicines.

The nurse pushes the cart from room to room and, at each stop, gives the patient the required doses of medication. The cart is locked mechanically when it is unattended.

The top surface of the medication cart is used as a work area for preparation of medications, drinks and the like.

Present medication cart designs generally do not effectively allow for the differing stature of users, and thus the height of the aforementioned work surface is a compromise and is only ergonomically correct for the average worker.

### SUMMARY OF THE INVENTION

In view of the preceding, it is an object of the invention to provide an improved cart, particularly one which addresses the differing needs of medication cart users by providing an adjustable height work surface. In the preferred embodiment, this object is achieved by employing a hydraulic lift system, which may be hand cranked or electrically or otherwise actuated.

In the preferred embodiment of the invention, the following features are also desired:
a. Providing for the locking of all drawers using one lock only;
b. Providing a mechanism whereby only one drawer may be opened at a time, thereby eliminating the possibility of the cart tipping over;
c. Providing attachment points for optional storage bins to contain garbage, drink bottles, sharp object containers and the like; and
d. Minimizing weight to facilitate easy rolling of the cart.

Further features of the invention will be described or will become apparent in the following detailed description.

### BRIEF DESCRIPTION OF THE DRAWINGS

The invention will now be described in detail, with reference to the accompanying drawings of the preferred embodiment, by way of example only, in which:

FIG. 1 is a perspective view of an example of a medical cart according to the invention, shown in its lowermost height setting;

FIG. 2 is a similar perspective view, but with the cart shown in a higher position;

FIG. 3 is a perspective view with the drawers, countertop and one side wall removed;

FIG. 4 is a close-up perspective view of the cart's anti-tip and lock linkage;

FIG. 5 is a cross section through the telescoping upright showing hydraulic cylinder in the retracted position;

FIG. 6 is a cross section through the telescoping upright showing hydraulic cylinder in the extended position; and

FIG. 7 is a multi-view drawing showing the dual master cylinder crank mechanism complete with lead screw and chaser nut.

### DETAILED DESCRIPTION

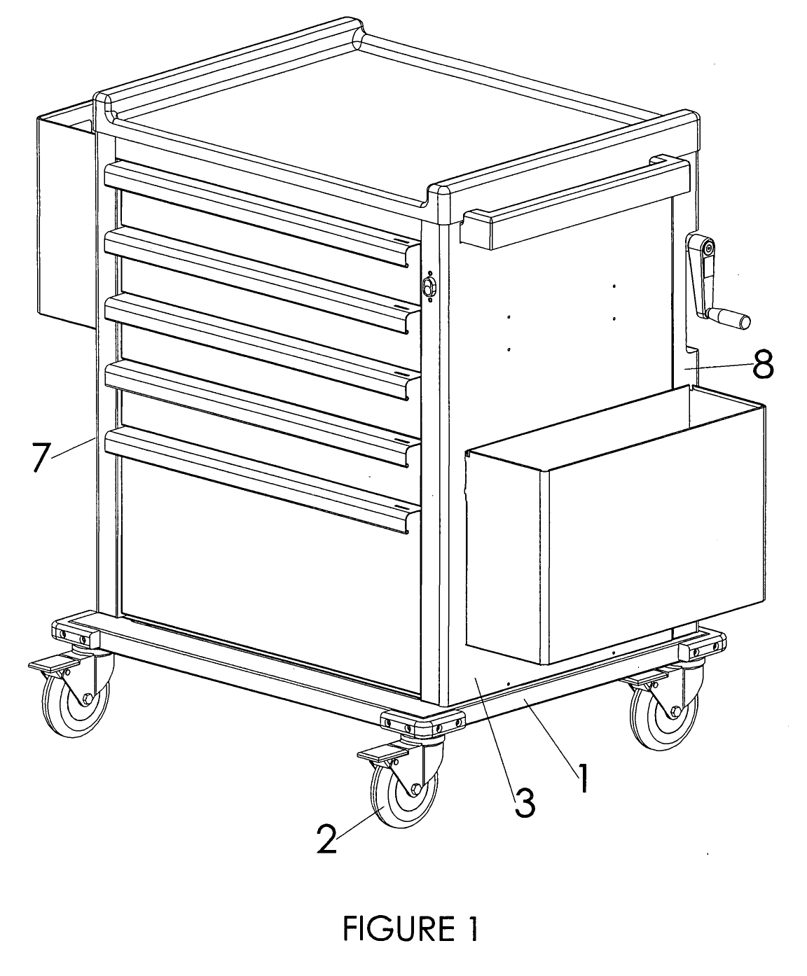

Referring to FIG. 1, a representative cart is shown. The cart has a base 1 on which four casters 2 are mounted to provide rolling support for the cart. Mounted on top of the base is the cabinet body 3 which provides support for all features common to other carts in the industry, such as drawers, locks and the like.

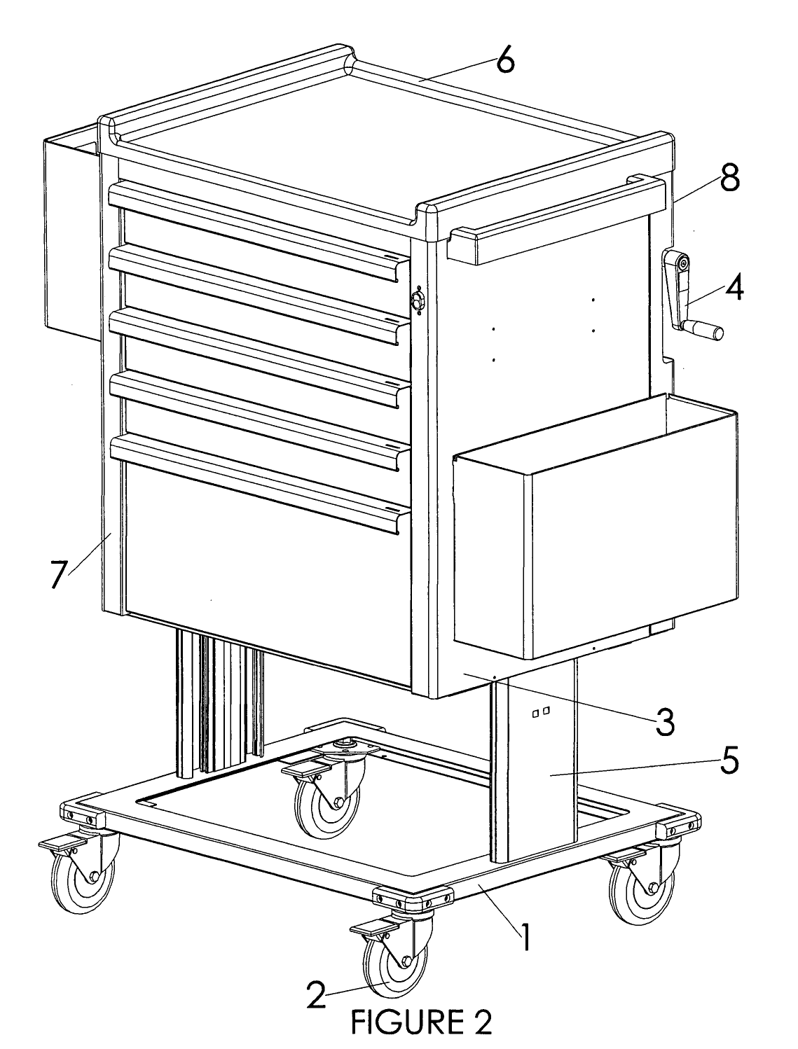

Referring to FIG. 2, the cabinet body 3 and the cabinet base 1 are separable using a lift system 5. The lift system is actuated by, for example, a hand crank 4 which enables users of the cart to raise or lower the height of the countertop 6, thereby accommodating users of different heights.

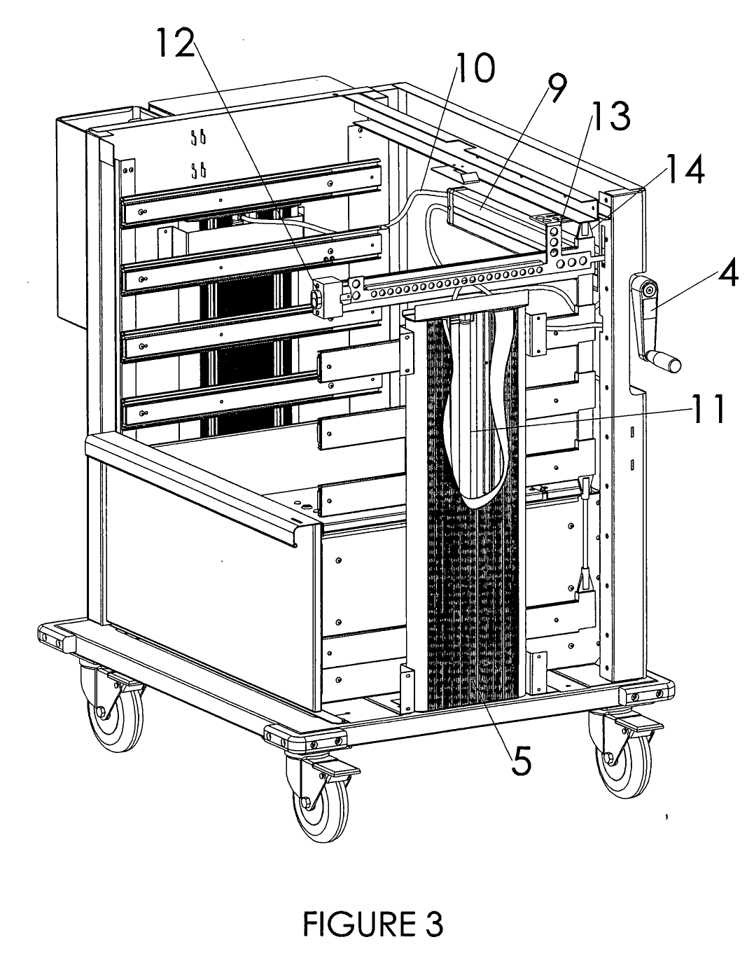

The cart body, preferably of steel, has a right side 3 and a left side 7 panel as well as a back panel 8 mechanically fastening the two sides together. The cart base 1 is separable from the cart body using telescoping uprights 5. FIG. 3 shows the hydraulic lift system, central locking and anti-tip mechanism. A hydraulic master cylinder 9 contains a crank 4. As the crank is turned clockwise, the fluid is forced through tubes 10 to hydraulic cylinders 11 which in turn raises the telescoping upright 5. Fluid from one pair of cylinders does not combine with fluid from the other pair of cylinders. In this manner, synchronization of the upward motion of both telescoping uprights is achieved.

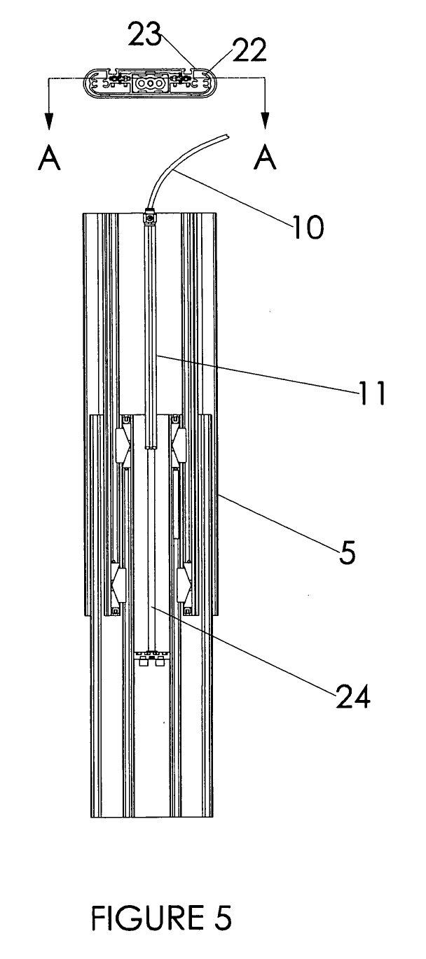

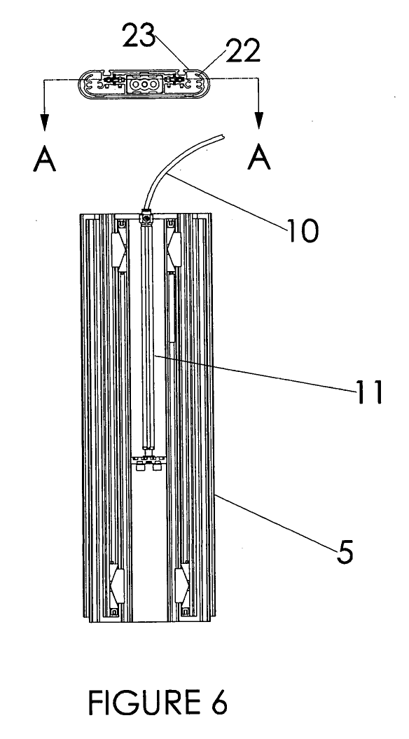

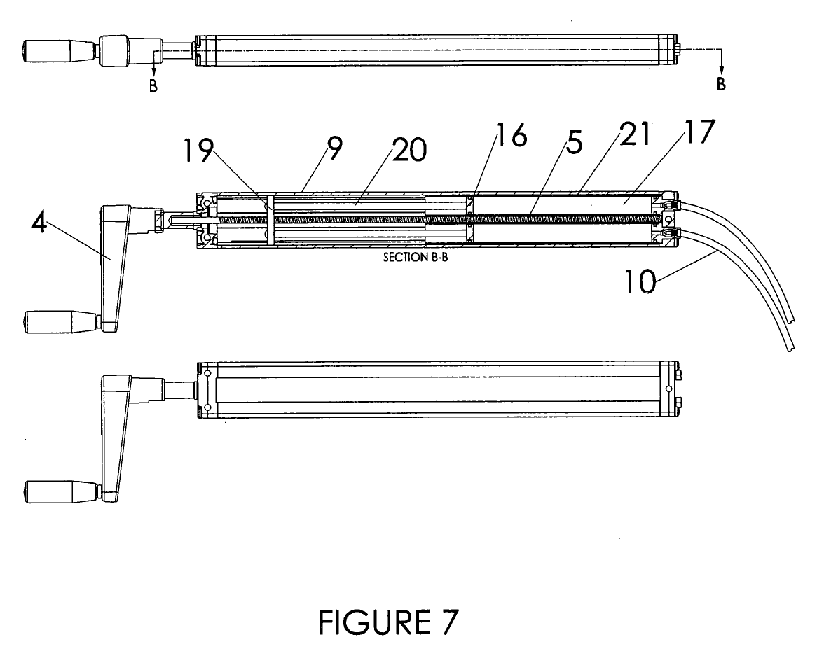

A more detailed view of the master cylinder is shown in FIG. 7. A hand crank 4 is shown connected to a lead screw 15 which, when rotated clockwise, moves the chaser nut 19. The chaser nut 19 is connected to the pistons 16 by a piston rod 20. As the pistons 16 move within the master cylinders 21 the hydraulic fluid 17 is forced out of the master cylinders 21 through the hydraulic tubing 10 and into the slave cylinders 11 housed within each telescoping upright 5. As the lead screw 15 is rotated counter-clockwise, the hydraulic fluid 17 is allowed to return to the master cylinder and the slave cylinders 11 retract, thereby lowering the cart. FIG. 6 is a detailed section view of the telescoping upright shown in the retracted position. The outer section 23 is fixed to the cart body and slides upward when the slave cylinder 11 is extended as shown in FIG. 5. The inner section 22 is affixed to the cart base.

Anti-tip functionality of the drawers is achieved through the use of an anti-tip mechanism generally as described in U.S. Pat. No. 6,238,024, supplied by Comp-X of Waterloo, Ontario, Canada. The mechanism has been modified to accommodate central locking. Referring to FIG. 3, an anti-tip bar 14 is used to actuate interlock cams contained within the ends of each runner. As one drawer is opened the cam rotates and forces the lower anti-tip bar down and the upper anti-tip bar up. Since the motion of the anti-tip bars is transferred to the next bar in the series, all other drawers are prevented from opening.

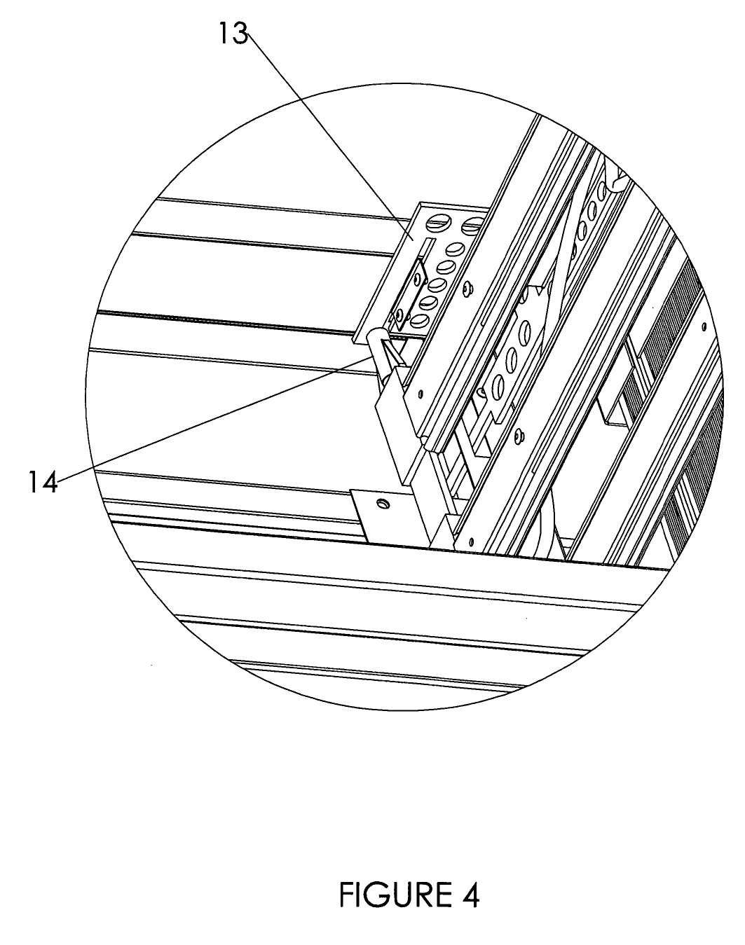

Central locking of the drawers is achieved by depressing lock 12 which engages linkage 13 and moves it rearward. As seen in FIG. 4, the rearward motion of the linkage 13 interferes with the upward motion of the anti-tip bar 14 and thus prevents all drawers from opening.

Further embodiments of the invention may vary from the preferred embodiment described herein. Many possible variations will be apparent to those knowledgeable in the field of the invention. The scope of the invention and of the claims is therefore not limited to this specific embodiment.

1. A cart comprising:
a base, having spaced-apart casters extending downwardly therefrom to support the base and provide mobility;
a cabinet body slidably mounted on said base, for vertical movement; and
a lifting mechanism acting between said base and said cabinet body to adjust the height of said cabinet body relative to said base.

2. A cart as in claim 1, wherein said lifting mechanism comprises at least one hydraulic cylinder arranged between said base and said cabinet body, and means for supplying or removing fluid from each said cylinder to extend or retract each said cylinder.

3. A cart as in claim 2, wherein there are two said cylinders on opposite sides of said cabinet body and base.

4. A cart as in claim 2, wherein said means for supplying or removing fluid comprises a hand crank connected to move a piston in each said hydraulic cylinder.

5. A cart as in claim 3, wherein said means for supplying or removing fluid comprises a hand crank connected to move a piston in each said hydraulic cylinder.

6. A cart as in claim 5, wherein said hand crank moves said pistons in unison.

7. A cart as in claim 1, particularly configured for dispensing of medication and having a plurality of drawers in said cabinet body.

8. A cart as in claim 7, further comprising anti-tip means arranged to prevent opening of more than one of said drawers at a time.

9. A cart as in claim 7, wherein said drawers are lockable via a single lock.

10. A cart as in claim 8, wherein said drawers are lockable via a single lock.

11. A cart as in claim 1, wherein said cabinet body is slidably mounted on said base by telescoping members on opposite side of said cabinet body and base.

12. A cart as in claim 2, wherein said cabinet body is slidably mounted on said base by telescoping members on opposite side of said cabinet body and base.

13. A cart as in claim 3, wherein said cabinet body is slidably mounted on said base by telescoping members on opposite side of said cabinet body and base.

14. A cart as in claim 4, wherein said cabinet body is slidably mounted on said base by telescoping members on opposite side of said cabinet body and base.

15. A cart as in claim 5, wherein said cabinet body is slidably mounted on said base by telescoping members on opposite side of said cabinet body and base.

16. A cart as in claim 6, wherein said cabinet body is slidably mounted on said base by telescoping members on opposite side of said cabinet body and base.

17. A cart as in claim 7, wherein said cabinet body is slidably mounted on said base by telescoping members on opposite side of said cabinet body and base.

18. A cart as in claim 8, wherein said cabinet body is slidably mounted on said base by telescoping members on opposite side of said cabinet body and base.

19. A cart as in claim 9, wherein said cabinet body is slidably mounted on said base by telescoping members on opposite side of said cabinet body and base.

20. A cart as in claim 10, wherein said cabinet body is slidably mounted on said base by telescoping members on opposite side of said cabinet body and base.
